(19) United States
(12) Patent Application Publication
(10) Pub. No.: US 2010/0108484 A1
(43) Pub. Date: May 6, 2010

(54) CONTACT SYSTEM, ESPECIALLY FOR A SWITCHGEAR

(76) Inventor: Michael Soukup, Kummersbruck (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 11/993,319

(22) PCT Filed: Jun. 14, 2006
(86) PCT No.: PCT/EP06/63201

§ 371 Date: Dec. 20, 2007

(30) Foreign Application Priority Data
Jun. 20, 2005 (DE) 10 2005 028 474.4

(51) Int. Cl. H01H 3/04; H01H 1/00

(52) U.S. Cl. 200/335; 200/290

(57) ABSTRACT

The invention relates to a contact system (2) comprising a contact bridge (15) that can be pivoted about an articulated axis (16) and is provided with a moving contact (11b, 12b) on the respective opposing ends (13, 14) thereof, each moving contact forming a contact point (K1, K2) with a fixed contact (11a, 11b) associated therewith. The articulated axis (16) is arranged in such a way that it can be displaced in the opening direction (19) of the contact points (K1, K2) along a guide (17) such that only a first contact point (K1) opens during normal operation, while both contact points (K1, K2) open in the event of an overcurrent and/or short circuit.

The invention relates to a contact system for closing and opening a current path. Current path is hereby understood as a pole path of a single-pole or multi-pole switchgear and/or protective gear, in particular a power switch, for switching a load.

A contact system of this type typically includes at least one contact point having a moving contact and a fixed contact and allowing a current path to be manually closed and opened with a switch latch. In addition to the manual switching function, the contact system responds automatically, in particular when being used in a power switch, in the event of overcurrent or short-circuit to a thermo-magnetically or electronically triggered overcurrent which opens the contact of the at least one contact point in the current path by applying an external force. To control the high disconnect power levels, arc quenching chambers in the form of so-called blow-out plates are provided in the opening region of the contact point.

Moreover, two contact points can be provided in a contact system, wherein the moving contacts of the contact system are synchronously switched relative to the associated fixed contacts by a contact bridge. For example, DE 198 36 549 A1 discloses a contact bridge which can move translationally to close and open the contact points, whereby the moving contacts are moved simultaneously into the respective closed and open positions. EP 0 538 149 B1 discloses a contact system with a rotating contact bridge, likewise for simultaneous actuation of the moving contacts of two contacts points.

It is an object of the invention to provide an especially suitable contact system with two contact points.

The object is attained in accordance with the invention by the features of claim 1. Accordingly, a contact bridge which is pivotable about a pivot pin is provided, wherein the pivot pin is arranged for movement along a guide track in the opening direction of the contact points. Under operating conditions, only a first contact point opens while an opposing second contact point is closed. Both the first and the second contact points open in the event of overcurrent or short-circuit.

According to a preferred variation, the contact bridge is coupled to a switch latch via a switch lever that is moving along the guide track. The switch lever engages hereby the pivot pin on the bridge side. The pivot pin can in principle also be arranged on the switch lever, in which case the guide track is suitably configured as an oblong guide mechanism, subsequently also referred to as slotted link, and provided on the contact bridge. Preferably, the slotted link is provided on the switch lever and the pivot pin is provided on the contact bridge. coupled and.

The slotted link forming the guide track has two opposing spaced-apart contact edges in opposite relationship with respect to the opening direction of the contact points. A first (upper) contact edge of the guide track represents an impact stop contacted by the pivot pin when the first contact point is closed. In this operating mode when the first and second contact points closed, a first spring element acts on the contact bridge as a compression spring, suitably in the region of the pivot pin. This spring element operates as a tension spring when only the first contact point is open during operation.

A second (lower) contact edge of the guide track represents a traction stop which the pivot pin contacts when the first contact point is open. This traction stop operates as a fixed support for the pivot pin in the event of overcurrent or short-circuit.

According to an important aspect of the invention, the second contact point is always closed, when the first contact point opens during normal operation. A suitably configured second spring element engages hereby on the second contact point and applies a spring force upon the corresponding moving contact in the closing position thereof. The spring force operating in the closing direction of the second contact point is preferably greater than the tension force of the first spring element. To easily and reliably open and close the first contact point during normal operation, a hinge bearing or pivot bearing is formed on the second contact point. The moving contact of the second contact point has hereby an arched or hemispherical contact surface.

According to a preferred development, the lever arm formed between the pivot pin and the moving contact of the first contact point is longer than the lever arm formed between the pivot pin and the moving contact of the second contact point along the contact bridge.

The fixed contact of the corresponding contact point is arranged on a leg of a busbar in facing disposition to the associated moving contact, wherein the busbar can be U-shaped, for example. The busbar, in particular as a result of its shape, reverses the current direction in the busbars on at least one contact point, however on both contact points. Consequently, in the event of overcurrent or short-circuit, a dynamic current force and a dynamic magnetic force is generated at the respective contact points which repulses the lever arm of the contact bridge supporting the corresponding moving contact. The spring element acting on the second contact point is dimensioned such that its spring or restoring force is smaller than the dynamic forces produced in the event of overcurrent or short-circuit.

When the protection function of the contact system is triggered by the dynamic forces, the pivot pin strikes the traction stop of the guide track. This produces a fixed support for the pivot pin, about which the contact bridge rotates automatically in the opening direction of the contact points.

The contact system is especially suited for single-pole or multi-pole switching gear used in AC current networks, or compact power switches rated for currents of, for example, 10 A to 2,500 A and interrupt ratings of 20 kA or higher. A spark quenching chamber associated with the opening region of each contact point.

An exemplary embodiment of the invention will now be described in greater detail with reference to a drawing.

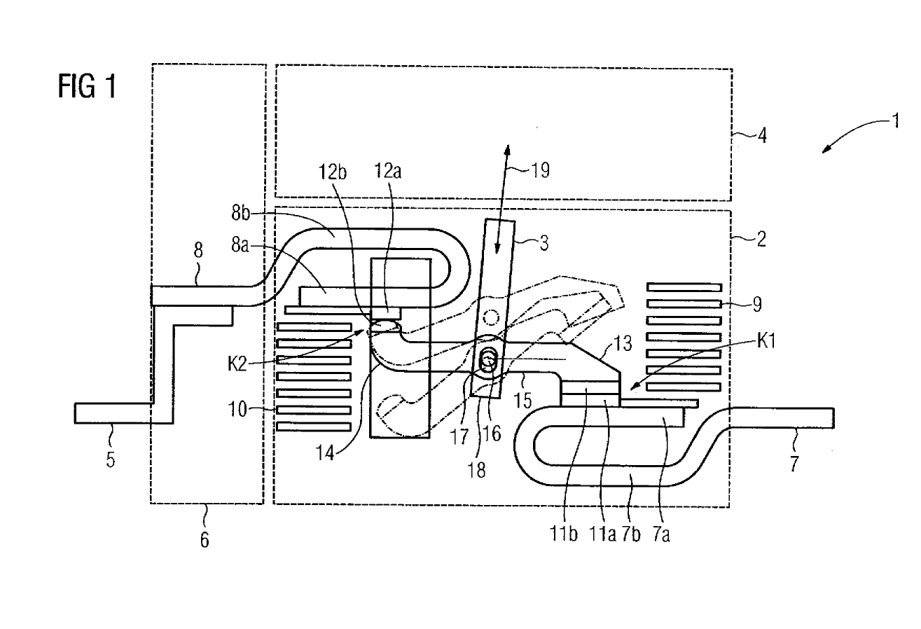

FIG. 1 shows schematically a contact system arranged in a power switch and having different switch positions of a contact bridge at two contact points;

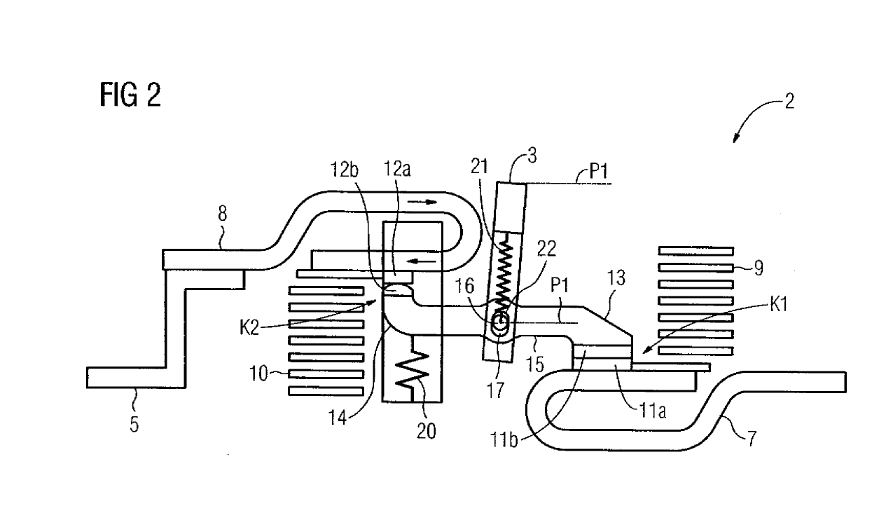

FIG. 2 the contact system in operating mode with closed contact points;

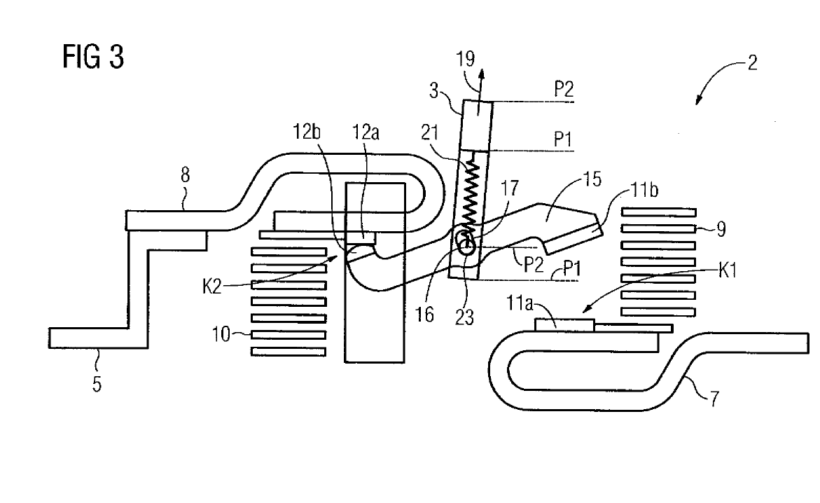

FIG. 3 the contact system in operating mode with one contact point open and one contact point closed;

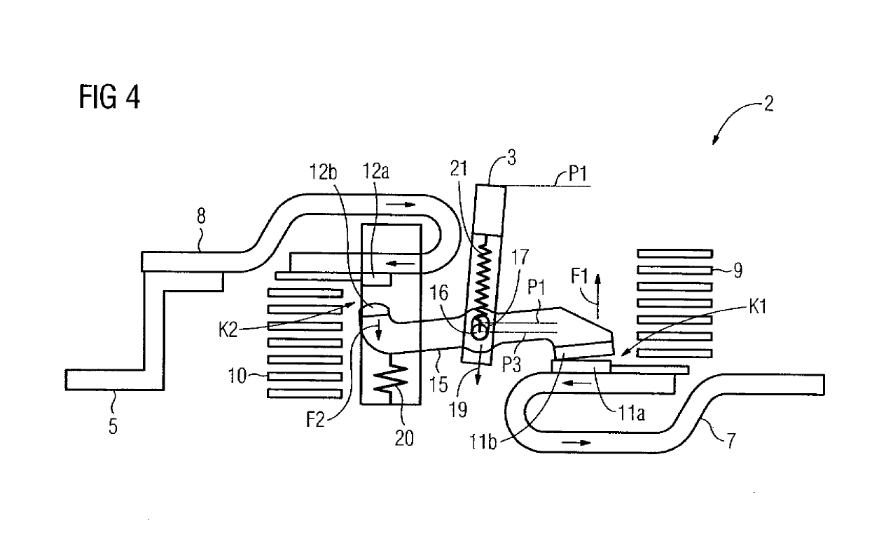

FIG. 4 the contact system in the event of short circuit while the contact points are opening; and

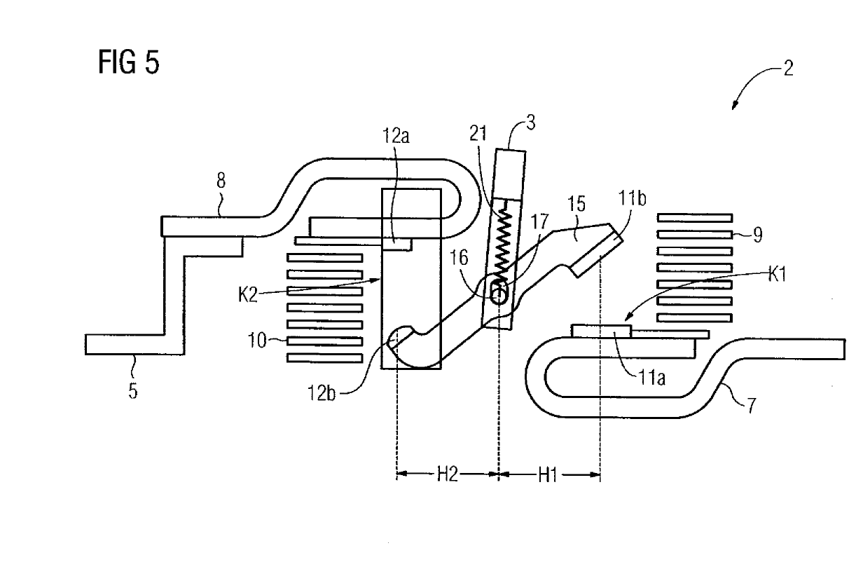

FIG. 5 the contact system under short circuit conditions with completely open contact points.

Corresponding elements in all Figures are provided with the same reference symbols.

FIG. 1 shows a switching gear and/or protection gear, for example a modularly constructed compact power switch 1, with a contact system 2 which is coupled to a switch latch 4 by a switch lever 3. For closing and opening a schematically depicted current path 5, the contact system 2 can be manually operated with the switch latch 4 by moving an actuating lever or a rocker button in a manner not illustrated in detail. The power switch 2 also includes a trigger unit 6.

Inside the contact system 2, the current path 5 leads to a busbar 7 of a first contact point K1 and an opposing additional busbar 8 of a second contact point K2. Spark quenching chambers 9 and 10, which are formed by so-called blow-out plates, are provided in the opening area of the two contact points K1 and K2. The two busbars 7 and 8 are each U-shaped and form a first busbar leg 7a, 8a facing the respective contact points K1, K2 and another busbar leg 7b, 8b facing away from the respective contact point K1, K2. Fixed contacts 11a, 12a of the contact point K1 and K2 are respectively arranged on the outside of the busbar legs 7a, 8a facing the respective contact points K1, K2. Each of the moving contacts 11b, 12b associated with a respective contact point K1, K2 is supported on a bridge end 13 and 14, respectively, of a contact bridge 15 of the contact system 2.

The contact bridge 15 has a pivot pin 16 disposed in the region between the two moving contacts 11 b and 12b. The pivot pin 16 is guided along a guide track 17 implemented in the switch lever 3 as an oblong recess near the lever end 18 facing the contact bridge 15.

FIG. 1 shows in form of a continuous line a contact bridge 15 in the closed operating state, wherein both the first contact point K1 and the second contact point K2 are closed. Shown in form of a dash-dotted line is the contact bridge 15, on one hand, in the normal operating state with the contact point 1 open and the contact point 2 closed, and on the other hand, in the event of a short-circuit, where both contact points K1 and K2 are open. Depending on the setting or position of the contact bridge 15, the switch lever 3 is positioned at different displacement positions along the opening and closing direction 19, hereinafter also referred to as displacement direction.

These different positions, namely the position P1 of the switch lever 3 and hence also of the pivot pin 16 when both contact points K1, K2 are closed, and the position P2 of the switch lever 3 and the pivot pin 16 when the contact position K1 is open and the contact position K2 is closed under normal operating conditions, are illustrated in FIGS. 2 and 3.

According to the embodiment of FIG. 2, a (second) spring element 20 configured in the exemplary embodiment as a compression spring engages the lever arm 14 of the contact bridge 15 at the second contact point K2 on the bridge side distal to the corresponding moving contact 12b. An additional (first) spring element 21 has spring ends which are attached, on one hand, to the switch lever 3 and, on the other hand, to the pivot pin 16. In the closed position P1 of the contact bridge 15 illustrated in FIG. 2, the spring element 21 operates as a compression spring on the pivot pin 16 connected to the contact bridge 15. In this position P1, the pivot pin 16 contacts a contact contour 22 configured as an impact stop of the slotted link 17 forming the guide track.

In the position P2 of the pivot pin 16 illustrated in FIG. 3, the spring element 21 operates as a tension spring. In the position P2, the pivot pin 16 makes contact with a contact or link contour 23 of the slotted link 17 which is located opposite the contact or link contour 22 and operates as a traction stop. For the opening and closing motion of the content bridge 15 in the operating mode, the contact point K2 forms a rotary or pivot bearing for the contact bridge 15. For supporting the resulting rotary or pivoting motion of the contact bridge 15, the moving contact 12b of the second contact point K2 has an arched or hemispherical shape in the region of the contact surface facing the fixed contact 12a.

FIGS. 4 and 5 illustrate the contact opening of both contact points K1 and K2 in the event of short-circuit or overcurrent. Because the current directions reverse due to the U-shaped configuration of the busbars 7 and 8, as indicated by the arrows shown in the region of the busbars 7, 8, the short-circuit current which tends to be many times higher than the current under normal operating conditions, generates corresponding dynamic forces F1, F2 at the contact points K1 and K2 in the opening directions 19 of the respective moving contact 11b and 12b. The contact point K1 opens first, whereafter the pivot pin 16 strikes the traction stop 23 along the guide track 17. Accordingly, a fixed support for the pivot pin 16 is established at this position P3, about which the contact bridge 15 rotates into the open direction 19. The dynamic forces F1, F2 overcome the spring force of the spring element 20 at the second contact point K2, causing the contact bridge 15 to pivot into the completely open position while simultaneously opening both contact points K1 and K2.

When the short-circuit is interrupted, the spring force exerted by the spring element 20 operating as a compression spring automatically closes the second contact point K2.

To support the dynamic forces F1, F2, the lever arms H1 and H2 of the contact bridge 15 formed between the first contact point K1 and the pivot pin 16, and between the pivot pin 16 and the second contact point K2, respectively, can have different lengths. Preferably, the lever arm H1 is longer than the lever arm H2.

The spring elements 21 and 20 acting on the pivot pin 16 and on the second contact point K2, in conjunction with the contact bridge 15 and its lever arms H1 and H2, therefore embody a lever arm mechanism for force transmission. With this lever arm system, or this lever arm mechanism, one of the contact points K1, K2 can then remain closed in the operating mode, and both contact points K1 and K2 can reliably open in the event of a short-circuit.

Accordingly, a contact system 2 is provided for realizing double-break contact points K1, K2 in the event of a short circuit, as well as a single-break contact, in particular of the first contact point K1, under normal operating conditions.

Such contact system 1 is particularly suited for a compact power switch 1 for switching as well as overcurrent triggering, and therefore protection of power components of the system, e.g., a motor. Power switches 1 equipped with such a contact system 2 are therefore particularly suited for interfacing to additional system components in a potentially complex energy distribution system.

1-13. (canceled)

14. A contact system for closing and for opening a current path, comprising a contact bridge having opposite bridge ends, each of which defining a moving contact and forming with a complementary fixed contact a contact point, said contact bridge being constructed such that in a normal operating mode only one of the contact points opens as the contact bridge rotates about a first pivot point defined by the other one of the contact points, and in the event of an overcurrent or a short-circuit both contact points open as the contact bridge rotates about a second pivot point at a distance to the first pivot point.

15. The contact system of claim 14, wherein the contact bridge has a pivot pin for defining the second pivot point, and further comprising a switch lever operatively connected to the pivot pin for actuating the contact bridge.

16. The contact system of claim 16, further comprising a first spring element having one end connected to the switch lever and another end connected to the pivot pin and constructed to impose a spring force on the one of the contact points.

17. The contact system of claim 15, further comprising a second spring element acting on the other one of the contact points and imposing a spring force on the other one of the contact points to seek a closed position.

18. The contact system of claim 17, wherein the spring force of the second spring element is greater than the spring force of the first spring element.

19. The contact system of claim 16, wherein the first spring element operates as a tension spring.

20. The contact system of claim 16, wherein the first spring element operates as a compression spring.

21. The contact system of claim 14, wherein the contact bridge has first and second lever arms of different lengths with respect to the second pivot point.

22. The contact system of claim 21, wherein the first lever arm is defined between the second pivot point and the one of the contact points, and the second lever arm is defined between the second pivot point and the other one of the contact points, wherein the first lever arm has a length which is greater than a length of the second lever arm.

23. The contact system of claim 15, wherein the switch lever is formed with a guide track for movably receiving the pivot pin of the contact bridge.

24. The contact system of claim 23, wherein the guide track has an impact stop to limit a movement of the pivot pin, when the one of the contact points closes.

25. The contact system of claim 23, wherein the guide track has a traction stop to limit a movement of the pivot pin, when the one of the contact points opens.

26. The contact system of claim 25, wherein the traction stop is constructed to act as a fixed bearing for the pivot pin in the event of an overcurrent or a short-circuit.

27. The contact system of claim 15, further comprising a switch latch, said switch lever being coupled with the switch latch.

28. The contact system of claim 14, wherein the moving contact of the other one of the contact points has an arcuate contact surface.

29. The contact system of claim 14, further comprising a spark quenching chamber disposed at an opening region of each of the contact points.

30. The contact system of claim 14, further comprising an approximately U-shaped busbar, wherein at least one of the fixed contacts is arranged on a busbar leg which is proximal to the moving contact that complements the one of the fixed contacts for reversal of a current direction.

31. A switchgear, in particular a power circuit breaker or a compact circuit breaker, with a contact system for closing and opening a current path, with the contact system including a contact bridge having opposite bridge ends, each of which defining a moving contact and forming with a complementary fixed contact a contact point, said contact is bridge being constructed such that in a normal operating mode only one of the contact points opens as the contact bridge rotates about a first pivot point defined by the other one of the contact points, and in the event of an overcurrent or a short-circuit both contact points open as the contact bridge rotates about a second pivot point at a distance to the first pivot point.
